(19) United States
(12) Patent Application Publication
(10) Pub. No.: US 2007/0212080 A1
(43) Pub. Date: Sep. 13, 2007

(54) Infrared Receiving Unit and Infrared Headphone/Hearing Aid

(76) Inventors: Roft Meyer, Wennigsen (DE); Wolfgang Niehoff, Wedemark (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/577,508

(22) PCT Filed: Oct. 28, 2004
(86) PCT No.: PCT/EP04/12200

§ 371 Date: Jan. 3, 2007

(30) Foreign Application Priority Data
Oct. 31, 2003 (DE) 103 51 286.1

(51) Int. Cl. H04B 10/06

(52) U.S. Cl. 398/202

(57) ABSTRACT

There is provided an infrared receiving unit which has an infrared receiver for receiving infrared signals and a transmitter search facility for carrying out an infrared transmitter search. Such an infrared receiving unit can be suitably used in an infrared headphone/hearing aid, a mobile terminal or an interpretation and conference system in order to correspondingly permit an IR search. With such a headphone/hearing aid different systems based on different modulation frequencies can be combined with each other so that the headphones/hearing aids can be used with other systems in a compatible and universal manner.

The present invention concerns an infrared receiving unit, an infrared headphone/hearing aid and an interpretation and conference system with a plurality of infrared headphones.

Wireless headphones or wireless hearing aids, the wireless signal transmission of which is effected on the basis of infrared (IR) have long been known in the state of the art. Infrared transmission systems can also be used for video or data transmission.

The transmission frequencies of infrared transmission systems of that kind are specified in the EN/IEC 61603 standard, that is to say in particular the carrier frequencies for example for audio transmission on the basis of infrared light. In the course of development of wireless IR transmission, a number of carrier frequencies have been established, which in part are not stated in the above-indicated standard. Thus for example the carrier frequencies 95 kHz and 250 kHz (left and right channel) have been provided for wireless IR headphones, while in more recent times modulation frequencies of 2.3 MHz and 2.5 MHz have become established. As a consequence thereof accordingly a number of systems are available on the market, which operate with different carrier frequencies, that is to say, those systems are not compatible with each other.

U.S. Pat. No. 5,152,003 discloses a system for the reproduction of previously recorded audio signals. A transmitter transmits various audio signals on different frequencies and at least one receiver has different reception channels which can be selected by manual input on the part of the user. As the various frequencies are known from the outset they can be associated with different keys in the receiving unit.

EP 872 049 B1 discloses a method of wireless optical communication between a transmitting station and a first receiving station which can receive data based on a first modulation method, and a second receiving station which can receive data based on a second modulation method.

DE 694 22 575 T2 discloses a system for use in an exhibition in order to provide the viewers with items of image information about an exhibit. In that case there are a plurality of transmitters which transmit image and audio information by way of a plurality of different transmission channels which are known from the outset.

DE 26 23 527 C2 discloses simultaneous transmission of messages in a plurality of separate signal channels which are known from the outset, by means of IR radiation. To select the appropriate channel it is only necessary for an oscillator to be switched stepwise from one frequency to the next.

A widespread location of use for the above-described IR headphones is represented by conference and interpretation systems. The participants in a conference are given an IR headphone in order for example to be able to follow the version of a lecture which is simultaneously translated into a given language. In the case of interpretation systems with IR headphones from a single supplier, no problems occur here, but rather problems occur when the products from different suppliers are used, which possibly do not operate on the same modulation frequencies. A further disadvantage of such systems is that they are only limitedly scaleable.

Further problems arise in connection with conference and interpretation systems as an association of the IR receivers with the respective languages involved requires a not inconsiderable amount of organisational complication and expenditure. Particularly in the case of large-scale events at which additional receivers are required, which are based on a different system, technical problems can arise by virtue of the lack of compatibility of the transmitters and the receivers.

Precise observance of the above-indicated standard is technically necessary only when IR transmitters or receivers co-operate with other systems or when different systems based on IR technology are to be operated in the same space. Apart from that, by virtue of the propagation physics of infrared light it is not necessary to select a different frequency outside a space as propagation of the infrared light is generally limited to a space or to a segment of space. Accordingly interference and disturbances cannot occur as long as a transmitter/receiver system is used, which has mutually matched modulation frequencies.

A further application of IR transmission technology is represented by hearing aids for the hard of hearing. Particularly in the USA installations are prescribed by statute which allow persons who are hard of hearing to be able to participate better in public life in public buildings, exhibitions, churches or the like, by means of such hearing aids. Many users of such hearing aids—above all for reasons of hygiene—prefer their own personal receivers. Problems accordingly occur if different modulation frequencies are used as the use of their own personal hearing aids is thus only very limitedly possible.

Accordingly the object of the present invention is to permit universal usability of infrared headphones/hearing aids. That object is attained by an infrared receiving portion as set forth in claim 1, an infrared headphone/hearing aid as set forth in claim 7, a mobile terminal as set forth in claim 8 and an interpretation and conference system as set forth in claim 9.

The invention is based on the notion of providing an infrared receiving unit which has an infrared receiver for receiving infrared signals and a transmitter search facility for carrying out an infrared transmitter search. An infrared receiving unit of that kind can be correspondingly used in an infrared headphone/hearing aid, a mobile terminal or in an interpretation and conference system in order to correspondingly permit an IR search.

Therefore there is further provided an IR headphone/hearing aid having an infrared receiver E for receiving infrared signals and a transmitter search unit SSE for carrying out an infrared transmitter search.

With a headphone/hearing aid of that kind different systems based on different modulation frequencies can be combined together so that the headphones/hearing aids are compatible and can be universally employed with other systems.

In accordance with a configuration of the invention the transmitter search unit SSE has a memory FBS for predetermined fixed frequency ranges. In that respect an automatic transmitter search is automatically effected for the frequency ranges stored in the memory FBS. That therefore provides for narrowing down the search, which considerably speeds up detection of the transmitters present.

In accordance with a further configuration of the invention the transmitter search unit SSE has a latch-in unit which stores the ascertained modulation frequency at which recognition has occurred.

In accordance with a further configuration of the invention the headphone/hearing aid has a switch unit S, by means of which the search of the transmitter search unit SSE can be enabled so that the search is continued or started afresh. By means of the switch unit S, a transmitter search can be continued until the correct or desired IR transmitter is selected.

In accordance with a further configuration of the invention the headphone/hearing aid has a display unit AE for displaying the IR transmitters detected by the search. Consequently the user can more easily select the desired transmitter.

In accordance with a further configuration of the invention the headphone/hearing aid has a code evaluation unit CAE which serves to associate predetermined applications with the detected transmitter. Applications of that kind can represent for example one of the languages being interpreted so that a language can be suitably selected.

The invention also concerns an infrared receiving unit for a headphone/hearing aid comprising an infrared receiver, a transmitter search unit and an audio output. Accordingly the signal processing required for the IR transmitter search and the necessary electronic system are disposed in a unit separate from the headphone. The headphone/hearing aid and the receiving unit can be sold separately.

The invention also concerns an interpretation and conference system having a plurality of above-described infrared headphones. Various transmitters and various headphones can be combined as desired, with such a system.

Further configurations of the invention are set forth in the appendant claims.

The present invention as well as embodiments thereof are described in detail hereinafter with reference to the drawing in which:

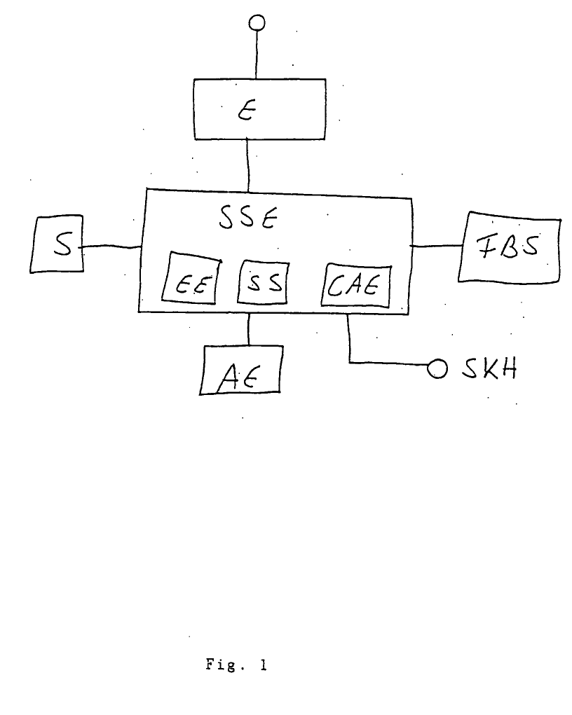

FIG. 1 shows a block circuit diagram of a part of the signal processing of a headphone/hearing aid in accordance with a first embodiment of the invention.

FIG. 1 shows a block circuit diagram of a part of the signal processing of a headphone/hearing aid in accordance with a first embodiment of the invention. FIG. 1 only shows those elements of the signal processing of a headphone/hearing aid, which are directly related to the search for infrared (IR) transmitters. Accordingly, illustrated therein are an IR receiver E, a transmitter search unit SSE, a switch unit S, a memory for a fixed frequency range FBS and a display unit AE.

The IR transmitter E receives IR signals and forwards them to the transmitter search unit SSE. A transmitter search is executed on the basis of the frequency ranges stored in the memory FBS for predetermined fixed frequency ranges. In that case the search can initially be limited only to the stored frequency ranges so that this provides a substantial improvement in the speed of the search. If no memory FBS is provided or if no value is stored therein, a search can be started in the entire IR frequency range. As soon as the IR transmitter has been found on the basis of its modulation frequency, that transmitter is stored in the transmitter memory SS and can be selected by means of the latch-in unit EE. The selected IR transmitter can be cancelled or enabled by means of the switch unit E so that a search is made for the next IR transmitter. The user of the headphone has the possibility, by means of the switch unit E, of changing the selected IR transmitter in accordance with his settings.

In addition thereto the arrangement can have a display unit AE which serves to display the selected IR transmitter or the IR transmitters which are stored in the transmitter memory SS.

As a further alternative a code evaluation unit CAE can be provided in the transmitter search unit SSE. Codes which are attached to the IR signal communicated from the IR transmitter can be evaluated by means of that evaluation unit. That code can represent for example items of information about the IR signals communicated by the IR transmitter, or the applications contained therein.

When a transmitter has been selected by the latch-in unit EE the signals received from that transmitter are outputted by way of the output SKH to the subsequent signal processing means of the headphone or the hearing aid.

In accordance with a second embodiment of the invention there is provided an interpretation and conference system. That system has a plurality of IR transmitters which each transmit at a specific modulation frequency. In that case each of those IR transmitters can communicate for example one of the languages into which a lecture at a conference is being simultaneously interpreted. In that situation the persons attending a conference receive an IR headphone in accordance with the first embodiment. As that headphone has a transmitter search function the person attending the conference can receive the signals of all IR transmitters in the conference room and can decode them. Accordingly it is possible for each person attending the conference to select for example the language that he wants, by selecting the desired IR transmitter by means of the transmitter search. That can be effected for example by the switch unit S being actuated as often as required until the desired IR transmitter and thus the desired language is received.

As an alternative thereto each IR transmitter can attach to the IR signal transmitted thereby a code which represents items of information about the language communicated by that transmitter. Accordingly the IR headphone in accordance with the first embodiment can receive that code and represent it on the display unit AE. On the basis of the codes shown the user can recognise the IR transmitter on which for example the language that he wants is being transmitted and thereupon can select the desired IR transmitter by means of the switch unit S.

In that respect the frequencies or frequency ranges stored in the memory FBS correspond on the one hand to the standardised carrier frequencies of the standard EN/IEC 61603 for audio, video and data applications as well as other frequencies which have already become established in practice but which are not firmly stated in the foregoing standard. These are for example the frequencies 95 kHz, 250 kHz, 2.3 and 2.5 MHz for audio applications in the domestic field. IR transmission is possible both on an analog and also on a digital basis, which requires corresponding carrier frequencies.

The languages of the interpretation system received from the various IR transmitters can be associated with given switches of the switch unit S in accordance with the preferences of the user or guidelines predetermined by the organiser so that a given language is always selected by the actuation of one of the switches. That can take place independently of the type of receiver and its individual frequency and/or data allocation and has in particular the advantage that the organisation of large-scale events is substantially simplified, more specifically in particular when a number of receivers of different systems and configurations are to be operated in parallel.

In accordance with a third embodiment which is based on the second embodiment, digital data can also be transmitted by the IR transmitters by means of IR signals. The IR transmitter search unit SSE and the other units shown in FIG. 1 can also be implemented in mobile terminals such as for example a PDA (Personal Digital Assistant) or a mobile telephone. When equipped in that way the user can search for various IR transmitters by means of his IR signals received by way of a mobile terminal or PDA and select one from which he would like to receive data or applications. If the mobile terminals have an audio output it is possible to connect a commercially available headphone or a hearing aid.

In accordance with a fourth embodiment of the invention a mobile terminal having an audio output can be used in the interpretation and conference system according to the second embodiment in parallel with or alternatively to the IR headphones or IR hearing aids. In that case the mobile terminal has a commercially available infrared interface or in addition thereto an IR search facility, as described in the third embodiment. Upon registration for a conference, when applying to enter a building such as for example a museum, a church, a fair or the like, personalisation of the mobile terminal can be effected, for example by allocating an identification ID. In that personalisation of the mobile terminal the mobile terminal can be advised on which frequencies which language is transmitted (in the case of an interpretation system) or on which frequencies further data and information are transmitted. In such a situation an IR search becomes superfluous as the mobile terminal is notified at the outset, which frequencies in the frequency range are of interest. Personalised information can be transmitted to the terminal by means of the terminal-specific identification ID.

In parallel with the personalisation process, a processing program or a transmission protocol can be transmitted to the mobile device. That transmission is preferably effected by way of IR signals but transmission by means of a network or another wired or wireless transmission, such as for example radio, is also possible. By means of the protocol which is transmitted in parallel with the personalisation information, the mobile terminal can be notified of the frequency on which it can receive the corresponding data or signals. The mobile terminal can also be positively synchronised by virtue of communication of the protocol, that is to say the corresponding frequencies are automatically adjusted or set. That has the advantage in particular that no additional hardware such as for example an IR search facility has to be implemented as that solution only requires a change in the software.

Preferably data, information and/or signal transmission is implemented by high-power IR transmitters (IrDA) in the interpretation and conference system in accordance with the fourth embodiment.

The mobile terminals used can be for example mobile telephones, PDAs, notebooks or the like as long as those mobile terminals have an IR interface.

The above-described IR transmission can be effected in analog or digital mode, which naturally requires suitable adaptation of the respective components. As an alternative to the above-described IR headphones, or hearing aids, with an IR search unit SSE, the transmitter search unit SSE, the memory FBS for predetermined frequencies, the latch-in unit EE, the switch unit, the display unit AE and the code evaluation unit can be implemented in a unit or housing which is separate from the headphone/hearing aid. That housing or unit then has an audio output to which a commercially available headphone or a commercially available hearing aid can be connected.

As described hereinbefore that housing or unit can also be implemented in the form of or by a mobile device.

1-12. (canceled)

13. An infrared receiving unit comprising:
an infrared receiver for receiving infrared signals;
a memory for storing predetermined frequency ranges; and
a transmitter search unit for carrying out an infrared transmitting frequency search within the predetermined frequency ranges stored in the memory.

14. A receiving unit as set forth in claim 13 further comprising a latch-in unit for latching in a received infrared transmitter.

15. A receiving unit as set forth in claim 13 further comprising a switch unit for enabling the transmitter search.

16. A receiving unit as set forth in claim 13 further comprising a display unit for displaying the infrared transmitters detected by the transmitter search.

17. A receiving unit as set forth in claim 16 further comprising a code evaluation unit for associating a detected infrared transmitter with a predetermined application.

18. An infrared headphone/hearing aid comprising an infrared receiving unit as set forth in claim 13.

19. A mobile terminal comprising a receiving unit as set forth in claim 13.

20. An interpretation and conference system comprising a plurality of infrared headphones/hearing aids including the receiving unit of claim 13 and/or a plurality of receiving units as set forth in claim 13 and infrared transmitters for transmitting infrared signals at specific frequencies.

21. A system as set forth in claim 20 wherein the infrared transmitter adds to the infrared signal a specific code corresponding to the specific frequency of the infrared signal.

22. A system as set forth in claim 20 comprising means for personalizing an infrared headphone comprising a mobile terminal comprising an infrared receiver for receiving signals, a memory for storing predetermined frequency ranges and a transmitting frequency search with the predetermined frequency ranges stored in the memory, or an infrared receiving unit comprising an infrared receiver for receiving signals, a memory for storing predetermined frequency ranges and a transmitting frequency search with the predetermined frequency ranges stored in the memory.

23. A system as set forth in claim 20 comprising means for transmitting an operating and/or processing program to a receiving unit comprising an infrared receiver for receiving signals, a memory for storing predetermined frequency ranges and a transmitting frequency search with the predetermined frequency ranges stored in the memory.

24. A system as set forth in claim 21 comprising means for transmitting an operating and/or processing program to a receiving unit comprising an infrared receiver for receiving signals, a memory for storing predetermined frequency ranges and a transmitting frequency search with the predetermined frequency ranges stored in the memory.

25. A system as set forth in claim 22 comprising means for transmitting an operating and/or processing program to a receiving unit comprising an infrared receiver for receiving signals, a memory for storing predetermined frequency ranges and a
